(19) United States
(12) Patent Application Publication
(10) Pub. No.: US 2004/0156367 A1
(43) Pub. Date: Aug. 12, 2004

(54) Hierarchically distributed scheduling apparatus and method

(75) Inventors: Celio V. Albuquerque, Encinitas, CA (US); Dennis P. Connors, San Diego, CA (US); Javad Razavilar, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Magis Networks, Inc., San Diego, CA

(21) Appl. No.: 10/365,353

(22) Filed: Feb. 11, 2003

(51) Int. Cl. H04L 12/28

(52) U.S. Cl. 370/395.4; 370/412

(57) ABSTRACT

The present invention provides a method and apparatus for distributing communication scheduling. The method and apparatus schedule communication across a plurality of links through a link scheduler and schedule flows to be communicated across the plurality of links through a flow scheduler. Typically, the link scheduler is positioned a distance from the flow scheduler. In one embodiment, the method and apparatus utilize a plurality of flow schedulers where each schedules flows across one of the plurality of links.

### BACKGROUND

1. Field of the Invention

The present invention relates generally to the optimization of throughput in a shared communication system, and more specifically to the optimization of throughput through distributed resource allocation.

2. Discussion of the Related Art

Contention based shared medium communication networks use a completely distributed approach, in which terminals listen to the channel and when the channel is idle, they transmit. This approach results in low throughput, since the probability of collision (two terminals transmitting at the same time) is very high, and when collision happens, data is typically not properly received by receiving terminals. This is the basic medium access control deployed by 802.11 wireless local networks.

High throughput shared medium communication networks typically utilize a central point within a network to provide scheduling of traffic flow communications over the network.

FIG. 1 depicts a distributed communication network 120 having a central access point (AP) 122 coupled with a plurality of terminals 124a-g. Each terminal 124a-g can further couple with one or more of the other terminals. Data and other information are supplied to and from the terminals through the AP 122 or through the other terminals. The data or information can include substantially any type of information including voice, text, graphics, multimedia (e.g., pay-per-view movies, TV programs, Internet video, camcorder video transmissions, MP3 audio, and voice flow) and other information. The data is communicated across links 126. A link allows one or more flows of information to utilize that link.

In previous systems, all communications are controlled by the central AP 122. Scheduling for each link and the flows communicated over each link are all processed at one central location. This requires a large amount of processing to be performed by the AP 122 to provide communication scheduling for the system 120. Further, this large amount of processing creates a communication bottle neck, which slows down the ability of the network to optimize communication.

### SUMMARY OF THE INVENTION

The present invention advantageously addresses the needs above as well as other needs through a method and apparatus for providing distributed scheduling control for a communication network. The method and apparatus are configured to provide for distributing communication scheduling. The method and apparatus schedule communication across a plurality of links through a link scheduler and schedule flows to be communicated across at least one of the plurality of links through a flow scheduler. Typically, the link scheduler is positioned at some distance from the flow scheduler. In one embodiment, the method and apparatus utilize a plurality of flow schedulers where each schedules flows across one of the plurality of links.

The method and apparatus prioritizes each of the plurality of links and schedules the links based on the priority of the links. Further, the plurality of flow schedulers prioritize the flows of each link and schedule the flows based on the priority of the flows. In scheduling the links, the link scheduler schedules the plurality of links based on a first round-robin scheduling where each link with the same priority is scheduled based on the first round-robin scheduling. Additionally, flows with the same priority are scheduled to be communicated across one of the plurality of links through a second round-robin scheduling.

In one embodiment, the method and apparatus are configured to adjust the link speed of the at least one of the plurality of links if the flows being communicated across the link utilize less than the allocated period of time.

The method and apparatus are configured to receive a plurality of requests for communication over one or more of the plurality of links and to prioritize each of the plurality of links. The method and apparatus can determine which terminals transmit and receive flows, at which link speed and at which moment in a given time frame those flows are communicated.

The method and apparatus determine if there is sufficient available time in a frame to satisfy all the requests for communication and schedule the communication of all the requests if there is sufficient time in the frame.

The method and apparatus are further configured to receive an allocated period of time in which to schedule flows and to determine if there is sufficient time in the allocated period of time to schedule all of the flows to be communicated. If there is sufficient time, the method and apparatus schedule all of the flows, and if there is not sufficient time schedule as many of the flows which can be communicated within the allocated period of time.

When a plurality of requests for communicating over a plurality of links is received, the method and apparatus determine the priority of each link and provide one of a plurality of degrees of qualities of service to each of the plurality of links, where links having the same priority are provided the same degree of quality of service.

The method and apparatus schedule a plurality of links for communication during a plurality of frames. For each frame, lengths of the frame are allocated for a control region and for one or more data regions. The control region and the one or more data regions are of variable length.

In one embodiment, the apparatus for providing communication includes a link scheduler configured to schedule communication over a plurality of links configured to provide communication paths for communicating data; and a link of the plurality of links being coupled with a flow scheduler configured to schedule flows to be communicated across the link. The link scheduler is positioned geographically distant from the flow scheduler. Each of the plurality of links is coupled with at least one of a plurality of flow schedulers configured to schedule flows. In one embodiment, the link scheduler generates a link-schedule list (LSL), and the flow scheduler generates a scheduled flow transmission list (SFTL). The link scheduler utilizes a reserved bandwidth table ad a best-effort table in scheduling the links. The flow scheduler utilizes a reserved bandwidth flow list and a non-reserved bandwidth flow list.

In one embodiment, the present invention provides a method for use in providing communication scheduling. The method includes scheduling at least one link communication within a time frame; determining if less than the entire time frame is scheduled; determining if a link speed associated with the at least one link communication can be reduced; and reducing the link speed associated with the at least one link communication.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a prior art distributed communication network having a central access point coupled with a plurality of terminals;

FIG. 2 depicts a simplified block diagram of a distributed network of the present invention;

FIG. 3A depicts a simplified block diagram of an access point (AP) in accordance with one implementation of one embodiment of the present invention;

FIG. 3B depicts a simplified block diagram of a terminal in accordance with one implementation of one embodiment of the present invention;

FIG. 4A shows a simplified block diagram of a sample TDMA communication of a series of frames;

FIG. 4B shows a simplified block diagram of a sample TDMA communication of a series of frames, similar to that shown in FIG. 4A, with an expanded view of a link transmission providing communication of three flows;

FIG. 5A depicts a simplified block diagram of a link transmission where four flows are scheduled for communication;

FIG. 5B depicts a simplified block diagram of the link transmission of the four flows as shown in FIG. 5A, where the link speed is adjusted to a slower speed;

FIG. 6 depicts a flow diagram of one implementation of one embodiment of a method for generating a link schedule list (LSL);

FIG. 7 depicts a flow diagram of one implementation of one embodiment of a method for reducing the link speed as shown in a step of FIG. 6; and

FIG. 8 depicts a flow diagram of one embodiment of one implementation of a method for generating a scheduled flow transmission list (SFTL).

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

Contention based shared medium communication networks use a distributed approach, where terminals listen to the channel and transmit when the channel appears idle. The distributed approach results in low throughput with a high probability of collision resulting in reduced or lost data through put. More advanced shared medium communication networks typically utilize a central point within a network to provide scheduling of traffic flow communications over the network. In such systems, all communications are controlled by the central AP 122. Scheduling for each link and the flows communicated over each link are all processed at one central location. This requires a large amount of processing to be performed by the AP 122 to provide communication scheduling for the system 120. Further, this large amount of processing creates a communication bottle neck, which slows down the ability of the network to optimize communication.

In order to reduce the amount of processing and the communication bottleneck, previous systems deploy vary basic scheduling techniques, such as polling. As a result, previous systems have very limited capabilities and are typically unable to provide different transmission priorities to different flows in the network, nor to differentiate the service provided to flows of different types of service and different communication requirements. For example, certain flows need low delay, others low jitter and high throughput, while other flows need high reliability (low packet error rate).

The present invention provides a method and apparatus for distributed communication scheduling to optimize the allocation of network resources. The present invention optimizes communication across communication links by in part distributing processing resources for scheduling the transmission of signals, data and/or information. The method and apparatus are further configured to provide scheduling of the transmission of data, signals and/or information in channel time slots of variable length. In one embodiment, the method and apparatus provide various degrees of quality of service to concurrent communication signals, data and/or information.

The distribution of processing communication scheduling significantly reduces, and in many configurations eliminates the bottle neck effects of network control as seen in previous communication systems. The distribution of processing enables more sophisticated scheduling techniques that are able to provide differentiated services to different classes of traffic. The distribution of processing reduces the amount of processing overhead any single component is required to perform, which provides increased response times and an increased rate at which data, information and/or signals can be communicated.

In one embodiment, the present invention utilizes a priority scheme to further optimize communication, thus giving priority to more time sensitive signals, data and/or information to improve the accuracy of the data and information. The present invention provides distributed network resources for communication scheduling of substantially any type of signal, data and information including, but not limited to, multimedia information (e.g., television, video, music, graphics, movies), voice data, electronic information (e.g., E-mails, facsimile data, Internet data, and other such information), and substantially any other type of data and information.

The terms signal, data and information are used interchangeably throughout the application, however, they are to be construed to include any data, information and/or signals capable of being communicated over a channel, where a channel is a medium on which data, information and/or signals are carried in a communication system.

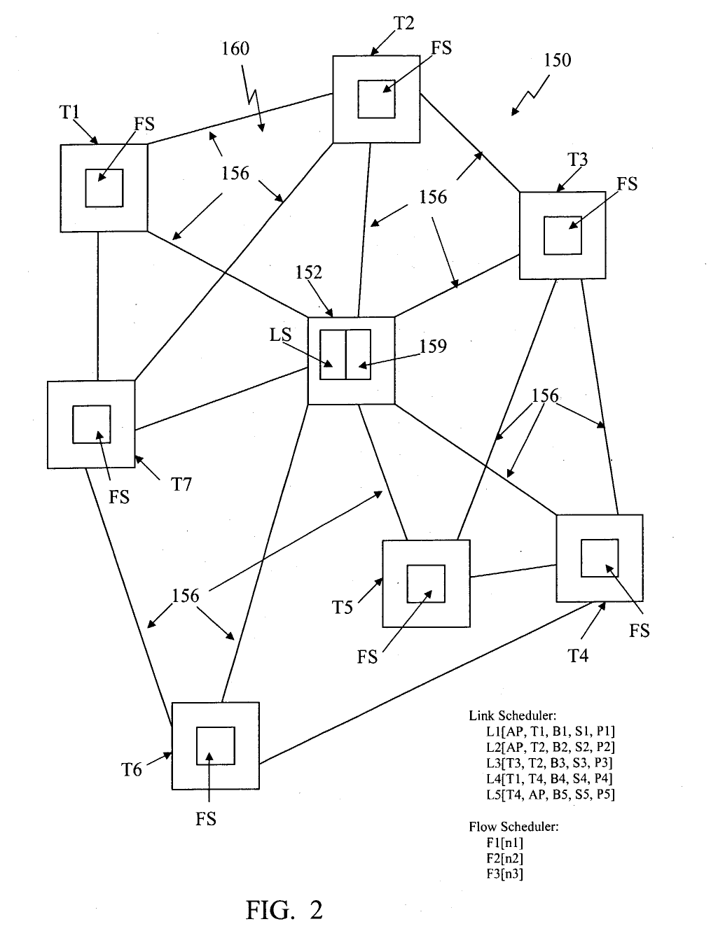

FIG. 2 depicts a simplified block diagram of a distributed network 150 of the present invention. The distributed network includes at least one access point (AP) 152, at least one, and generally a plurality of terminals T1-T7, and a distributed scheduling system 160. The terminals T are preferably positioned at distances from each other and from the AP providing a geographically distributed network; however, one or more terminals can coexist in a single location. Further, the AP 152 can be configured to include one or more terminals. Still further, the distribution does not require large distances. The AP and terminals are typically located at some distance from each other, for example, the terminals can be located at different locations in a home or office. As examples, terminals can be different devices within a single dwelling (e.g., computer(s), television(s), stereo(s) and other appliances within a home), the terminals can be located at different buildings of a campus, different floors of a building, different offices in different cities, and other such configurations.

The network 150 is configured to provide communication between the AP 152 and the terminals T1-T7. Additionally, each terminal can be configured to communicate with one or more of the other terminals. Communication between the AP and the terminals, as well as communication directly between the terminals, is performed over links 156. Each link is configured to provide one or more flows of communication, and are generally bi-directional but can be one directional. The links can be established through substantially any type of shared communication channel including: direct coupling, such as coaxial cable, twisted wired pairs, fiber optics and other such direct coupling; wireless communication, such as RF, and other such wireless communication; and substantially any shared channel for communication.

The method and apparatus provide a hierarchically distributed scheduling network or system 160 configured to provide various degrees of quality of service to communication flows. A flow is a sequence of packets which have sequential dependence on one-another, originate from the same source, and/or carry a common information stream. A packet is a unit of data, information and/or signal that is transmitted on a communications channel. The scheduling system 160 operates in substantially any shared communication technology including TDMA, and substantially any other shared communication technology. In one embodiment, the network 150 is a TDMA/TDD radio communications network containing a plurality of mobile terminals. A terminal may communicate with other terminals through the shared medium, where, generally, one terminal is transmitting at a given time. Terminals may move and the quality of the link between them may vary. The quality of the link between two terminals determines the highest speed at which data may be transmitted in the link. Several flows may be transmitted over a link between two terminals, and each flow may have varying quality of service (QOS) requirements.

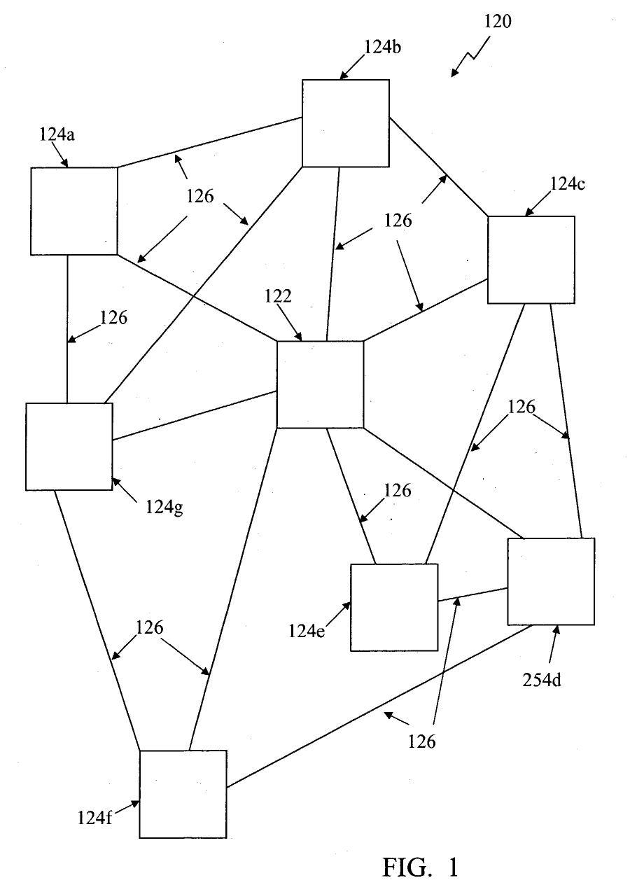

The distributed scheduling system 160 determines scheduling and communication control of communication traffic flows over the links 156 by, in part, providing various degrees of quality of service to traffic, providing fairness among communication links and flows, accommodating dynamic frames with variable length control regions and variable length data regions, and increasing reliability of link transmissions. The scheduling system 160 is distributed throughout the network 150 between the AP 152 and at least one, and generally a plurality of the terminals T1-T7. The scheduling system 160 provides distributed processing for the scheduling of communications resulting in the distribution of processing overhead in allocating network resources. The distribution of processing reduces, and preferably eliminates the communication bottle neck occurring in previous communication systems that result from the use of the single central access point 122 (see FIG. 1).

Still referring to FIG. 2, in one embodiment, the distributed scheduling system 160 is organized as two functional subsystems or levels, a centralized link scheduler (LS) operating from the access point (AP) 152 and one or more flow schedulers (FS) operating from the plurality of terminals. The LS determines link transmissions of each communication frame. Each link transmission may have a different transmission speed and duration. The FS determines how many packets from each flow are to be transmitted during each link transmission. In one embodiment, the AP can also include an FS if the AP operates in dual mode as an AP as well as a terminal. In one embodiment, each terminal does not include an FS; one or more terminals share an FS. An FS can be a separate component of the network 150 and provide flow scheduling to one or more terminals accessing the remote FS. In one embodiment, a terminal can include a plurality of flow schedules configured to schedule communication over a plurality of links from the terminal.

In scheduling, the LS generates a link schedule list (LSL) that is distributed to the FSs. One example of an LSL for a frame is shown below in Table 1.

TABLE 1
Link Scheduling List (LSL)

| Link | From | To | At time | At speed | # of Packets |
|---|---|---|---|---|---|
| L1 | AP | T1 | B1 | S1 | P1 |
| L2 | AP | T2 | B2 | S2 | P2 |
| L3 | T3 | T2 | B3 | S3 | P3 |
| L4 | T1 | T4 | B4 | S4 | P4 |
| L5 | T4 | AP | B5 | S5 | P5 |
| L6 | T2 | AP | B6 | S6 | P6 |
| . | . | . | . | . | . |
| . | . | . | . | . | . |
| . | . | . | . | . | . |

In the example shown in Table 1, the LS scheduled six link transmissions for a given communication frame. In the first link transmission, P1 packets are scheduled to be transmitted at time B1 and at speed S1, from the AP to terminal T1 ; (i.e., L1[AP, T1, B1, S1, P1]). The other link transmissions follow the same format, for instance, in the fourth link transmission L4, terminal T1 is scheduled to transmit P4 packets to terminal T4, starting at time B4, at speed S4 (i.e., L4[T1,T4,B4,S4,P4]). Upon receiving the LSL from the LS, the FS at each terminal designated in the LSL executes the transmission for the designated frame and at the designated link (L).

Table 2 below shows one example of a flow schedule list generated by an FS operating at a terminal, for example terminal T1. The flow list shown in Table 2 corresponds with link L4 shown in Table 1.

TABLE 2
Flow Schedule List (FSL)

| | # of | Reserved | Instantaneous | Transmit | |
|---|---|---|---|---|---|
| Flow | Packets | BW | BW | Time | Frame |
| F1 | n1 | RBW₁ | | B4₁ | 4 |
| F2 | n2 | RBW₂ | | B4₂ | 4 |
| F3 | n3 | | IBW₃ | B4₃ | 4 |

As shown in Table 2, the FS at terminal T1 schedules three flows for transmission from time B4 of the allotted frame on an associated link (e.g., link L4). In this example, flow F1 transmits n1 packets, flow F2 transmits n2 packets and flow F3 transmits n3 packets, where the sum n1+n2+n3=P4.

In providing the link scheduling and flow scheduling, both the LS and FS take into account terminal traffic load status and flow requirements. The traffic load and flow requirements are utilized, at least in part, to ensure a quality of service (QOS). The quality of service is dependent on a priority of the flows. In one embodiment, these priorities are based on the type of traffic being communicated. The priority of flows is further described below.

Flows can further reserve bandwidth from the AP. Flows having reserved bandwidth are given a higher priority over flows without reserved bandwidth. In one embodiment, the present invention additionally provides an equitable, rotational or round-robin scheduling of links and flows. The round-robin scheduling improves fairness among the flows. Links and flows within a priority level are granted bandwidth on a rotational scheme helping to ensure accuracy and avoid back logs of flows. In one embodiment, the round-robin scheduling is based on the order in which requests for flow communications are received.

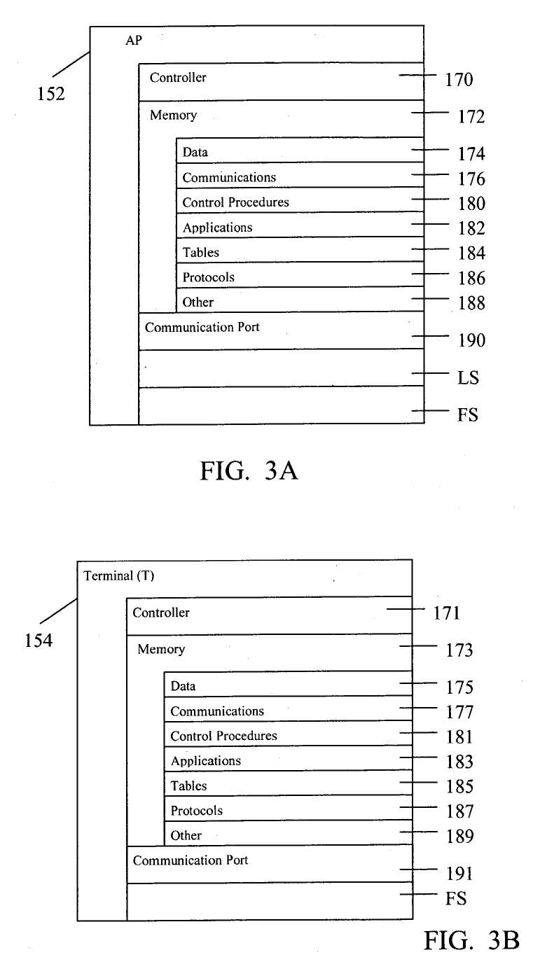

FIG. 3A depicts a simplified block diagram of an AP 152 in accordance with one implementation of one embodiment of the present invention. The AP includes a processor or controller 170 which is implemented through a state machine, a computer, a micro-processor or substantially any other controller known in the art. The AP further includes a memory 172 for storing data 174, communications 176, control procedures 180, applications 182, tables 184, protocols 186 and other data, parameters and processes 188 utilized by the AP. The AP also includes the LS, and in one embodiment, includes an FS. A communication port 190 is included within the AP to provide communication between the AP and the terminals, as well as the AP with other components (not shown) of the network 150 or other external networks (not shown) coupled with network 150, such as the Internet or other communication networks. The communication port can be substantially any communication port known in the art for providing communication over a shared medium including a transceiver for wireless communication, a modem, an Ethernet port, an optical communication port and substantially any other communication port or combination of ports. In one embodiment, the AP includes a link quality control mechanism 192 configured to determine and aid the AP in maintaining the quality of the data communicated across the network 150.

FIG. 3B depicts a simplified block diagram of a terminal 154 in accordance with one implementation of one embodiment of the present invention. The terminal includes a processor or controller 171 which is implemented through a state machine, a computer, a micro-processor or substantially any other controller known in the art. The terminal further includes a memory 173 for storing data 175, communications 177, control procedures 181, applications 183, tables 185, protocols 187 and other data, parameters and processes 189 utilized by the terminal. The terminal 154 also includes the FS. A communication port 191 is included within the terminal to provide communication between the terminal and the AP and other terminals, as well as with other components (not shown) of the network 150 or other external networks (not shown) coupled with network 150, such as the Internet or other communication networks. The communication port can be substantially any communication port known in the art for providing communication over a shared medium including a transceiver for wireless communication, a modem, an Ethernet port, an optical communication port and substantially any other communication port or combination of ports.

In one embodiment, the LS is operated from the AP 152 and is responsible for, at least in part, determining which terminals T transmit and receive flows, at which link speed and at which moment in a frame those flows are communicated.

The AP determines, with the aid of the LS, which terminals T transmit flows at given times. The LS utilizes timing details of the communication protocol, for example the timing of TDMA frames, in order to compute the time available for data transmission. Timing details include, but are not limited to, beacons and control packets, transmission preambles and headers, gap intervals, bandwidth parameters and other such details. The LS (and the FS) does not require the control regions of the frame to be fixed. In fact, the length of the control regions, as well as the data regions, may vary from frame to frame. The ability to handle such dynamic frames allows the transmission of, for example, a variable length link scheduling list (LSL) in a beacon region of a TDMA frame. Based on the length of control region per frame, the LS adjusts the data regions and the amount of available time for scheduling of link communications.

For convenience, the invention is described below in relation to a TDMA/TDD communication system. However, it will be apparent to one skilled in the art that the present invention can be equally applied to other shared medium communication protocols and systems without departing from the novelty of the invention.

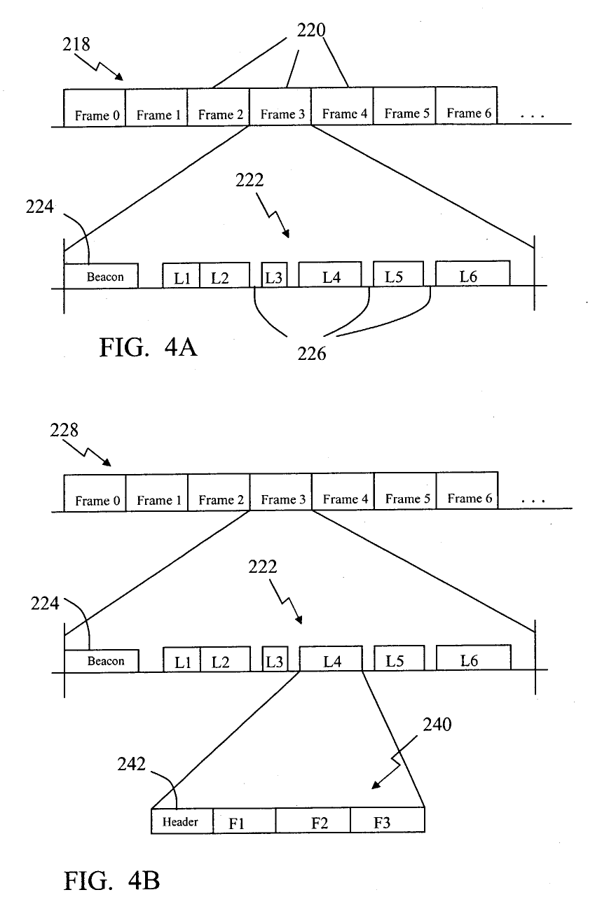

FIG. 4A shows a simplified block diagram of a sample TDMA communication 218 of a series of a plurality of frames 220. It is assumed that frame 3 provides the communication of data with the same link and flow scheduling as shown in Tables 1 and 2. In this example, the link-scheduling list (LSL) is broadcast from the LS to the terminals T1-T7 (see FIG. 2) in a control and beacon region 224 of the TDMA frame 3. The frame can additionally include other data and/or parameters. The remainder of the frame is the data region 222 which varies depending on the control region and other frame parameters. Frame 3 is also shown to include some gaps 226 between link transmissions. In this example, links L1 and L2 are downlink transmissions (AP-to-T1, and AP-to-T2) and there are no gaps between them. Links L3 and L4 are direct link transmissions (T3-to-T2 and T1-to-T4), and links L5 and L6 are uplink transmissions (T4-to-AP and T2-to-AP). The control details of the TDMA frames are fed as inputs to the LS in order for the LS to calculate when each link transmission should start and end, and to keep track of the available time in the TDMA frame.

The LS generates as an output, at least, the LSL. In one embodiment, the LS operating on the AP utilizes the following inputs:

a) link speed for each link defining a maximum speed at which packets can be transmitted over each link. In one embodiment, a link speed table is utilized which contains the maximum speed packets can be transmitted over each link. The LS schedules link transmissions at speeds lower than or equal to the value specified as the link speed;

b) reserved bandwidth, which may be maintained in a reservation table identifying flows having reserved bandwidth and the amount of bandwidth reserved;

c) flows awaiting transmissions which do not have reserved bandwidth. In one embodiment, a best-effort request table is generated defining non-reserved traffic specifying the traffic's desired instantaneous bandwidth (IBW). Each entry on this table generally reflects the amount of data waiting for transmission on a terminal's outbound queue; and

d) a frame timing descriptor, for example a TDMA frame timing descriptor, containing the timing details of the specific TDMA frame, such as the timings of beacons and control packets, transmission preambles and headers, gap intervals and other such parameters.

The LS determines the length of a frame, the frame overhead and determines the time available in the frame. The available time is then used to calculate the starting transmission time, duration and speed of link transmissions. Each link scheduled for transmission is entered into the LSL. As the number of links scheduled for transmission increase, the length of the LSL also increases. The LSL is transmitted to the terminals. Further, the LSL is, in one embodiment, transmitted at a low link speed to improve the reliability, as a result, the longer the LSL, the higher its transmission overhead. This overhead is particularly significant for short frames. Consequently, in one embodiment, the LS attempts to minimize the length of the LSL in order to reduce the overhead of the LSL.

In minimizing the LSL, the LS further optimizes the frame bandwidth by, in part, minimizing the number of link transmissions per frame. The more link transmissions scheduled, the longer the LSL, and generally, the more the frame control overhead, such as link transmission preambles, gap intervals and feedback control channels, resulting in a greater mis-use of the bandwidth. Limiting the number of link transmissions per frame reduces the LSL and its overhead, thus further optimizing bandwidth.

The LS additionally optimizes the communication of the network 150 by balancing the link scheduling between terminals, limiting backlogs and ensuring equitable transmission between terminals. The LS services requests from all terminals in a fair manner. The LS utilizes priorities of flows in determining scheduling of flows to ensure balanced transmission between terminals. For example, flows with reserved bandwidth are given higher priority. Flows belonging to the same priority class or level are then served in a round-robin sequence.

The distributed scheduling system 160 further optimizes scheduling in some embodiments by assigning communications or requests from the AP at a higher priority than terminal communications or requests. Because the performance of the entire network relies on the performance of the AP, providing AP communications with higher priority than terminal communications allows the LS to schedule the transmission of AP communications prior to terminal communications. This reduces the load of the AP which generally improves the performance of the AP and thus the entire network 150. Even though, in some configurations, the AP may have more memory than the terminals, assigning a higher priority and serving the AP requests first, reduces the AP overhead and improves performance, which generally results in an overall improvement of the network performance.

The scheduling method and apparatus additionally improves the reliability of data transmissions by utilizing an optimum link speed in which to transmit the data. In one embodiment, the AP is configured to monitor the link speed and load of each link. If the load is low, and the bandwidth is available, the AP reduces the speed of transmissions, resulting generally in an increase in reliability of the communicated data. In one embodiment, a link quality table is used to maintain the maximum link speed supported by each active communication link, including direct links between terminals. When determining an optimal link speed for a given link transmission the LS takes into account not only the maximum speed allowed for that link but also the current network traffic load. When the load of the link is low, the link speed is set to a lower speed, reducing the bit error rate, increasing the reliability of the link and providing a more robust link communication.

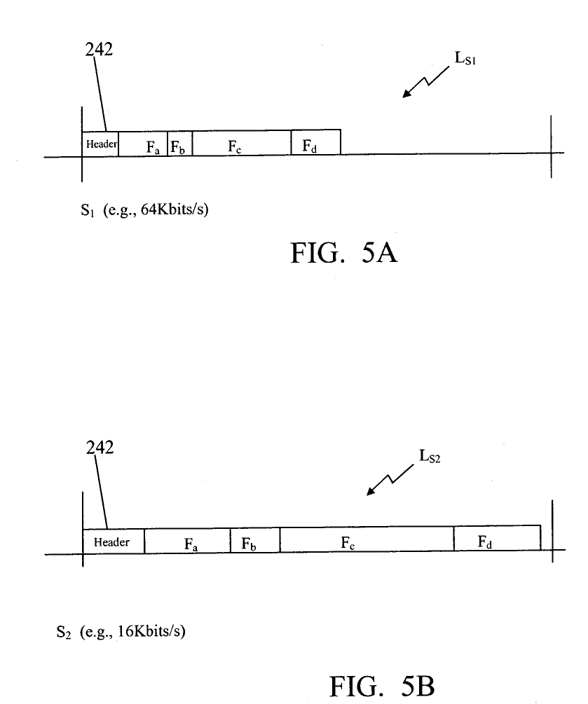

FIG. 5A depicts a simplified block diagram of a link transmission Lₛ₁ where four flows Fₐ-F_{d} are scheduled. The link speed is at a first speed S₁ (e.g., 64 Kbits/s). The link speed is such that the four flows complete transmission well before the end of the frame. Thus, the LS can adjust the link speed to a second slower speed S₂. The communication at the first speed S₁ provides accurate communication (for example, at S₁ the link experiences a bit error rate (BRE) of 10⁻⁶). However, reducing the speed improves the accuracy of the transmission.

FIG. 5B depicts a simplified block diagram of the link transmission L_{S2} of the four flows Fₐ-F_{d} as shown in FIG. 5A, where the link speed is adjusted to a slower speed S₂ (e.g., 16 Kbits/s) to provide slower transmission of the four flows and substantially filling the frame. The slower transmission results in a communication with a reduced bit error rate (e.g., 10⁻⁹). Additionally, transmitting at a slow speed may require less power, thus reducing costs. Further, transmitting at reduced power reduces interference with other links and other networks.

In some instances, the link speed for a specific link is not available to the LS. In such scenarios, in order to evaluate the quality of the link, the LS schedules a short link transmission (e.g., 1 packet) across the link at a low link speed that fits in the frame. When the short link transmission is received the AP, through a link quality control mechanism 192, determines the quality of this short transmission, for instance by measuring the transmission signal to interference (or noise) ratio (SIR). Good quality links have high SIR and typically support high speed data. Noisy links have low signal to interference ratio and typically only support low speed data. The AP then updates the entry regarding the quality of this link for subsequent frames. Thus, the AP is capable of determining a maximum link speed to optimize bandwidth while maintaining the accuracy of the data communicated.

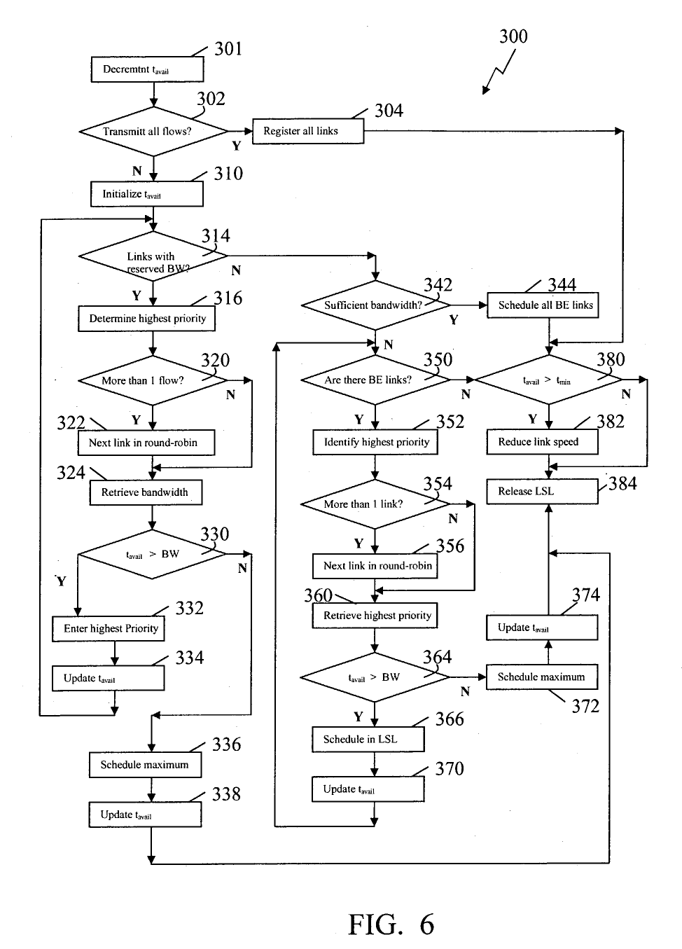

FIG. 6 depicts a flow diagram of one implementation of one embodiment of a method 300 for generating the LSL. In step 301, the frame control overhead is decremented from the available frame time. In step 302, it is determined if there is sufficient time within the available time to transmit all the flows for all the links. If there is sufficient time, step 304 is entered where all links are registers in the LSL, and each link is removed from the reserve list and the best-effort list. Following step 304 the method proceeds to step 380 where it is determined if there is sufficient bandwidth to reduce the speeds of any of the links to improve transmission.

If, in step 302, there is not sufficient time to allocate time for each link, step 310 is entered where the LS initializes the available time for a frame. The method then proceeds to identify the highest priority links, and in step 314, the method determines if there are links that have reserved bandwidths. If there are links with reserved bandwidth, step 316 is entered where the highest priority of the link or links having reserved bandwidths is determined. In step 320 it is determined if there is more than one link with the same highest priority. If there is more than one link with the highest priority, step 322 is entered where the method 300 identifies which of the plurality of links having the highest priority is scheduled next in the round-robin schedule to be communicated. Following step 322, and if in step 320 there is only one link at the highest priority, the method proceeds to step 324.

In step 324, the bandwidth requirements for the highest priority next round-robin link is retrieved. In step 330, it is determined if there is sufficient time in the frame to satisfy the reserved bandwidth. If there is sufficient time, step 332 is entered where the highest priority link is entered into the LSL. In step 334, the available time in the frame is updated. Following step 334, the method returns to step 314 to determine if there are any remaining links with reserved bandwidth that have not been allocated time in the frame.

If, in step 330, there is not sufficient time in the frame, step 336 is entered where a maximum amount of the frame is scheduled for a maximum number of packets to be communicated. The flow scheduler determines the flows for the packets to fill the allocated time; remaining flows for the link are maintained and are scheduled in later frames based on the priority of the links (described further below). In step 338, the allocated time is updated (e.g., to substantially zero due to the scheduling of the maximum packets being about equal to the available time). The method then proceeds to step 384 where the LSL is released.

If, in step 314, there are no links having reserved bandwidths (or no additional links with reserved bandwidth that have not been allocated time), step 342 is entered where it is determined if there is sufficient time in the frame (tₐᵥₐᵢₗ) to satisfy the bandwidth of all of the links without reserved bandwidth (e.g., those links with only best-effort flows). If, in step 342, it is determined there is sufficient time in the frame, step 344 is entered where all of the best-effort links are scheduled in the LSL, removed from scheduling consideration, and the method 300 proceeds to step 380.

If, in step 342, there is not sufficient time available in the frame (i.e., tₐᵥₐᵢₗ<tₚ), the method proceeds to schedule a maximum available number of packets. In scheduling the maximum packets, step 350 is entered where the method determines if there are best-effort links yet to be scheduled. In one embodiment, the method identifies best-effort links by utilizing a best-effort table registering those non-reserved bandwidth flows that are to be transmitted through best-efforts.

If, in step 350, there are additional links with best-effort flows to be communicated, step 352 is entered where the highest priority of the best-effort links is identified. In step 354, it is determined if there is more than one link having the highest priority. If there is more than one, step 356 is entered where it is determined which of the plurality of the highest priority links is scheduled next from the round-robin schedule to be communicated and noted as the highest priority link. Following step 356, and if, in step 354, there is only one link at the highest priority, the method proceeds to step 360.

In step 360, the highest priority link is identified and the bandwidth for the link is retrieved. In step 364, it is determined if there is sufficient time in the frame to satisfy the bandwidth for the best-effort link. If there is sufficient time, step 366 is entered where the best-effort link is entered into the LSL and the best-effort link is removed from the best-effort table. In step 370, the available time in the frame is updated. Following step 370, the method returns to step 350 to determine if there are any remaining best-effort links not attempted.

If, in step 364, there is not sufficient time in the frame, step 372 is entered where a maximum amount of the frame is scheduled for a maximum number of packets to be communicated and noted as the highest priority link. In step 374, the available link time is updated. The method then proceeds to step 384 where the LSL is released.

Following step 344 and if in step 350 it is determined there are no further best-effort links, step 380 is entered where the method 300 determines if there is sufficient time in the frame to slow the speed of one or more links. If there is sufficient time, step 382 is entered where the link speed for one or more links is reduced. Following step 382, and if in step 380 there is not sufficient time to reduce the link speed of the links, step 384 is entered where the LSL is returned or released.

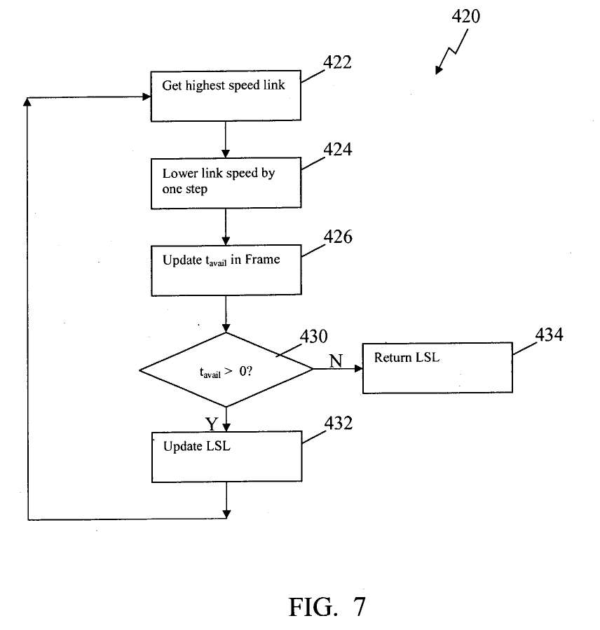

FIG. 7 depicts a flow diagram of one implementation of one embodiment of a method 420 for reducing the link speed as shown in step 384 of FIG. 6. In step 422, the link with the highest link speed is determined. In step 424, the link speed of the link with the highest link speed is reduced. In one embodiment, the method and apparatus of the present invention operates at discrete link speeds (e.g., 6, 9, 12, 18, 36, 54 Mbps). As such, the reduction of link speed in step 424 can result in a lowering to the next lower speed supported by the link. For instance, when reducing the speed of a 36 Mbps link, the speed can be reduced by one step to 18 Mbps. In step 426, the available time in the frame is updated. In step 430, it is determined if there is additional time remaining in the frame. If there is available time, step 432 is entered where the LSL is updated and the method 420 returns to step 422 to get the next link which now has the highest link speed. If in step 430, there is not additional time in the frame, step 434 is entered where the LSL is updated and returned to be communicated to the terminals.

FIG. 4B shows a simplified block diagram of a sample TDMA communication of a plurality of frames 220, similar to that shown in FIG. 4A, with an expanded view of a link transmission 240 of link L4 providing communication of three flows F1-F3. For consistency and simplicity, it is assumed in this example that link L4 provides the communication of data with the same flow scheduling as shown in Table 2. Link L4 is also shown to include a header field 242 in the link transmission. Referring to Table 1, link L4 is a direct communication from terminal T1 to terminal T4 (L4[T1, T4, B4, S4,P4]). Link L4 communicates P4 packets distributed between flows F1 (n1packets), F2 (n2 packets) and F3 (n3 packets), where n1+n2+n3=P4.

The FS (see FIG. 2) operates from the terminals, and in one embodiment, each terminal includes an FS. The FS keeps track of the flows to be communicated to and from the terminal. In one embodiment, the FS utilizes a reserved flow list containing flow identifiers and bandwidths associated with reserved flows for the link, and a non-reserved flow list containing flow identifiers and desired instantaneous bandwidths associated with non-reserved flows for the link. In one embodiment, the FS utilizes a flow request list which is a single list containing the reserved and non-reserved flows.

The flow request list includes flow identifiers for flows requesting to be communicated to and from the terminal with accompanying reserved and/or desired bandwidth. Flows with reserved bandwidth are maintained at a higher priority than best-effort flows without reserved bandwidths. For example, flows with reserved bandwidth are placed at the beginning of the flow request list (or in a separate section of the flow request list, or in a separate reserved flow request list) and sorted by priority. Non-reserved flows are then placed below the reserved flows (or in a separate section of the flow request list, or in a separate non-reserved flow request list) and sorted by priority.

When the terminal receives the LSL, the FS utilizes the LSL to generate a scheduled flow transmission list (SFTL) designating the flows to be transmitted within the time of the frame allotted to the link. Table 3 shows an example of a flow request list maintained by the FS in generating a SFTL having both reserved and non-reserved flows sorted by priority, where the reserved flows are entered into the list above the non-reserved flows.

TABLE 3
flow request list

| | | | Instantaneous |
|---|---|---|---|
| FID | Priority | Reserved BW | desired BW |
| F3 | A1 | RBW₃ | |
| F2 | A2 | RBW₂ | |
| F6 | C3 | RBW₆ | |
| F1 | E2 | | IBW₁ |
| F5 | F1 | | IBW₅ |
| F4 | G2 | | IBW₄ |
| . | | | |
| . | | | |
| . | | | |

Table 4, below, shows an example of an SFTL including the time allocated (TA₁₋₆) within a frame for each flow.

TABLE 4
Scheduled Flow Transmission List (SFTL)

| | | Instantaneous | | |
|---|---|---|---|---|
| FID | Reserved BW | desired BW | Frame | Time allocated |
| F3 | RBW₃ | | 7 | TA₁ |
| F2 | RBW₂ | | 7 | TA₂ |
| F6a | RBW₆ₐ | | 7 | TA₃ |
| F6b | RBW_{6b} | | 8 | TA₄ |
| F1 | | IBW₁ | 8 | TA₅ |
| F5 | | IBW₅ | 9 | TA₆ |
| F4 | | IBW₄ | 10 | TA₇ |
| . | | | | |
| . | | | | |
| . | | | | |

In one embodiment, the FS records each flow to be transmitted from the terminal along with flow identifiers (FID), flow priorities, reserved bandwidths associated with reserved flows, and instantaneous bandwidths (IBW) desired by non-reserved flows. The FS also records the time allocated in the LSL for the link to determine the number of packets that can be scheduled for transmission on the link based on the time allocated. Utilizing the FIDs, flow priorities, reserved bandwidths and instantaneous bandwidths for the flows requesting transmission across the link, the FS generates the SFTL which schedules when and which flows are to be transmitted across the link.

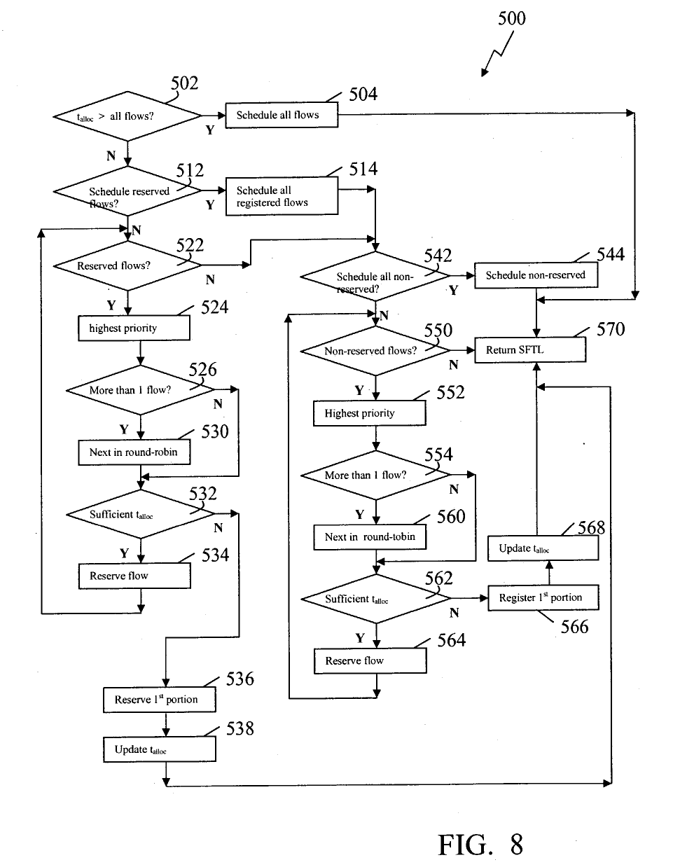

FIG. 8 depicts a flow diagram of one embodiment of one implementation of a method 500 for generating the SFTL. In step 502, it is determined if there is sufficient time within the time allocated to the link to transmit all flows across the link. If there is sufficient time, step 304 is entered where all flows are scheduled in the SFTL, and each flow is removed from the flow request list. The method proceeds to step 570 where the SFTL is forwarded.

If, in step 502, there is not sufficient allocated time for each flow, step 512 is entered where the method determines if there are flows with reserved bandwidth and if there is sufficient time in the time allocated to the link to schedule all of the flows with reserved bandwidth. If there is sufficient time, step 514 is entered where all the flows with reserved bandwidth are scheduled for transmission, entered in the SFTL and removed from the flow request list. If there is not sufficient time the method identifies the highest priority flows. In step 522, the method determines if there are flows with reserved bandwidth that have not been scheduled (e.g., reserved flows in the flow request list). If there are, step 524 is entered where the highest priority of the reserved flows is determined. In step 526, it is determined if there is more than one flow with the highest priority. If yes, step 530 is entered where it is determined which of the plurality of flows is next in the round-robin schedule and is noted as the highest priority flow.

Following step 530, and if in step 526 there is only one flow with the highest priority, step 532 is entered where it is determined if there is sufficient time in the allocated time to communicate the highest priority reserved flow. If there is sufficient time, step 534 is entered where the flow is reserved and added to the SFTL, removed from the flow request list and the time allocated to the link is decremented. The method 500 returns to step 522 to determine if there are any remaining flows with reserved bandwidth requesting transmission that have not been attempted.

If in step 532 there is insufficient time, step 536 is entered where the flow is divided such that a first portion of the flow, having a bandwidth equal to or less than the amount of allocated time, is reserved and added to the SFTL. A second portion is maintained in the request list and the request list is adjusted to reflect the reduced amount of bandwidth needed to satisfy the second portion. In one embodiment, a request for reserved bandwidth is submitted to reflect the reduced bandwidth to satisfy the second portion. In step 538, the allocated time is updated (e.g., to substantially zero due to the first portions bandwidth being about equal to the available time). The method then proceeds to step 570 where the SFTL is released.

Following step 514, and if in step 522 it is determined there are no further reserved flows that have not been scheduled, step 542 is entered where the method determines if there are non-reserve flows and if there is sufficient time remaining in the time allocated to the link to schedule all of the non-reserved flows. If there is sufficient time, step 544 is entered where all of the non-reserve flows are reserved, added to the SFTL and removed from the flow request list. If there is insufficient time, step 550 is entered where it is determined if there are non-reserve flows to be scheduled that have not been scheduled. If there are remaining non-reserve flows, step 552 is entered where the highest priority of the non-reserve flows is identified. In step 554, it is determined if there is more than one flow with the highest priority. If yes, step 560 is entered where it is determined which of the plurality of non-reserve flows is next in the round-robin schedule.

Following step 560, and if in step 554 there is only one flow with the highest priority, step 562 is entered where it is determined if there is sufficient time in the allocated link time to communicate the highest priority, non-reserve flow. If there is sufficient time, step 564 is entered where the flow is reserved, added to the SFTL, removed from the flow request list and the allocated link time is decremented. Following step 564, the method 500 returns to step 550 to determine if there are remaining non-reserved flows requesting transmission that have not been scheduled.

If, in step 562 there is insufficient time, step 566 is entered where the flow is divided such that a first portion of the flow has a bandwidth equal to or less than the remaining amount of allocated time and is registered in the SFTL. A second portion is maintained in the flow request list and the flow request list is adjusted to reflect the reduced amount of bandwidth needed to satisfy the second portion. In step 568, the allocated time is updated to substantially zero. The method then proceeds to step 570 where the SFTL is released.

If in step 550 it is determined that there are no additional non-reserve flows that have not been scheduled, the method 500 enters step 570. In step 570, the SFTL is returned and implemented when the link is scheduled for transmission.

In one embodiment, the hierarchically distributed scheduling method and apparatus of the present invention provide various degrees of quality of service (QOS) to various types of traffic. The scheduling of flows is, at least in part, based on various traffic flow classifications. The quality of the service provided depends on the nature and priority of the traffic. At least two main classes of traffic are supported, real-time and non-real-time traffic. Real-time traffic is characterized by either constant bit rate (CBR) or variable bit rate (VBR) traffic, and non-real-time traffic has an unspecified bit rate (UBR) traffic.

Traffic flows may have various priorities, and real-time flows are generally assigned a higher priority than non-real-time flows. Further, there may be various priorities of real-time flows and various priorities of non-real-time flows. For example, in real-time multimedia flows such as pay-per-view movies, TV programs, Internet videos, camcorder video transmissions, MP3 audio, voice flows and other such multimedia flows may each be assigned different priorities. Non-real-time flows may also be assigned varying priorities. Real-time traffic typically has bandwidth reserved. Reserved traffic is guaranteed to be served by the scheduler, for instance, if a real-time flow reserves a bandwidth of 10 Mbps, the flow is guaranteed by the scheduler to be able to transmit 10 Mbits every second, so long as the bandwidth remains reserved to that flow.

At least two main classes of traffic are supported, reserved traffic and non-reserved traffic. Non-reserved traffic is served depending upon bandwidth availability. Link transmissions may be composed of reserved and non-reserved traffic, allowing variable bit rate services that have a minimum bandwidth to exploit the available bandwidth when needed. One example of a mapping between traffic classes and the quality of service provided to those classes is shown in Table 5.

TABLE 5
Mapping of Classes of Traffic and Delivered Quality of Service

| Class of | | | Bandwidth | |
|---|---|---|---|---|
| Traffic | Application | Traffic | request | QOS |
| Real- | Sustained | CBR | Reservation | Bandwidth |
| time | Multimedia | Constant bit | table | guaranteed |
| | | rate | Instantaneous | |
| | | | request table | |
| | Bursty | VBR | Instantaneous | Minimum |
| | Multimedia | Variable bit | request table | bandwidth |
| | | rate | and | guaranteed, |
| | | | Reservation | excess |
| | | | table | traffic may |
| | | | | use the |
| | | | | available |
| | | | | bandwidth |
| Non- | Data | UBR | Instantaneous | Available |
| real- | | Unspecified bit | request table | bandwidth |
| time | | rate | | |

Additionally, in one embodiment, communications or requests from the AP are assigning higher priorities than terminal communications or requests.

The scheduling method and apparatus determine scheduling of links base, at least in part, on the priority of the flows communicated across each link. As discussed above, flows with reserved bandwidth, generally, have higher priority than flows with non-reserved bandwidth. In one embodiment, links are given a priority based on the highest priority flow of the flows to be communicated across the link. A link with a flow having a reserved bandwidth is given a higher priority than a link with only non-reserved bandwidth flows.

In one embodiment, a link priority list or table (a combination of the reserve table and the best-effort table) is generated to aid the distributed scheduling system 160 to determine the highest priority links, and to provide a balanced and round-robin transmission schedule across all of the links. The link priority list contains entries for each link with data to be communicated along with a priority for the link and a requested bandwidth to satisfy the bandwidth for all of the flows to be communicated across the link, i.e., the bandwidth request contains the cumulative request of all flows sharing the link.

In one embodiment, links are stored in the link priority list in a manner that is utilized to provide fairness and quality of service. The management of the link priority list ensures a balanced and rotational scheduling (i.e., a round-robin scheduling). The link priority list is sorted by priority. The round-robin scheduling is maintained by placing newly submitted link transmission requests after existing link requests in the link priority list having the same priority as the newly submitted link request. The priority of the link request, and thus the position within the link priority list, is set to the priority of the flow with highest priority.

In one embodiment, the reserved request list or table and non-reserve request list or table are utilized as inputs to the LS, and have entries specifying the request for reserved bandwidth and instantaneous bandwidth for links that do not have reserved bandwidth. The contents of the reserved and non-reserve request tables change dynamically from frame to frame. New requests from terminals can arrive at the AP at every frame. Furthermore, the amount of downlink data waiting for transmission on the outbound queues of the AP also generates entries in the reserved and non-reserve request table. In one embodiment, the scheduling method and apparatus store requests in the reserved and non-reserve request tables in a manner that is utilized to provide fairness and quality of service. The management of the reserved and non-reserve request tables ensures a balanced and rotational scheduling (i.e., a round-robin scheduling).

In one embodiment, the reserved and non-reserve tables are sorted by priority, reducing the amount of states required by the LS to perform the round-robin scheduling. The round-robin scheduling is maintained by placing newly submitted link requests after existing requests in the reserved and non-reserve tables having the same priority as the newly submitted request. In one embodiment, the tables include request fields. The request field contains the amount of bandwidth reserved or requested for a link transmission, i.e., it contains the cumulative request of all flows sharing the link. The priority of the link request, and thus the position within the reserved and non-reserve tables, is set to the priority of the flow with highest priority.

In one embodiment, the FS utilizes a flow request list or table. The flow request table is managed through a similar means as that of the reserved request list, and non-reserve request table. In one embodiment, the flow request table is sorted by the priority of the flows, thus reducing the amount of states required by the FS to perform the flow round-robin scheduling. The flow round-robin scheduling is maintained by placing newly submitted flow requests after existing flow requests in the flow request table having the same priority as the newly submitted request.

While the invention herein disclosed has been described by means of specific embodiments and applications thereof, numerous modifications and variations could be made thereto by those skilled in the art without departing from the scope of the invention set forth in the claims.

What is claimed is:

1. A method for providing communication scheduling, comprising the steps of:
distributing communication scheduling including:
scheduling communication across a plurality of links through a link scheduler;
scheduling flows to be communicated across the plurality of links through a flow scheduler; and
positioning the link scheduler a distance from the flow scheduler.

2. The method as claimed in claim 1, further comprising the steps of:
providing a plurality of flow schedulers; and
each flow scheduler scheduling flows across one of the plurality of links.

3. The method as claimed in claim 2, further comprising the steps of:
prioritizing the flows of each link through one of the plurality of flow schedulers; and
the step of scheduling the flows including scheduling the flows based on the priority of the flows.

4. The method as claimed in claim 1, further comprising the steps of:
prioritizing each of the plurality of links;
the step of scheduling the links including scheduling the links based on the priority of the links;
prioritizing the flows; and
the step of scheduling the flows including scheduling the flows based on the priority of the flows.

5. The method as claimed in claim 1, wherein:
the step of scheduling the links including scheduling the plurality of links based on a first round-robin scheduling.

6. The method as claimed in claim 5, further comprising the steps of:
prioritizing each of the plurality of links; and
the step of scheduling the links based on the first round-robin schedule including scheduling each link having the same priority based on the first round-robin scheduling.

7. The method as claimed in claim 6, further comprising the steps of:
prioritizing the flows; and
the step of scheduling the flows including scheduling each of the flows having the same priority of flows to be communicated across one of the plurality of links through a second round-robin scheduling.

8. The method as claimed in claim 1, further comprising the steps of:
allocating a period of time to at least one of the plurality of links for communicating at least one flow across the link during the allocated period of time; and
adjusting a link speed of the at least one of the plurality of links.

9. The method as claimed in claim 8, wherein:
the step of adjusting the link speed including adjusting the link speed of the at least one of the plurality of links if the at least one flow utilizes less than the allocated period of time.

10. The method as claimed in claim 8, further comprising the steps of:
allocating a period of time of a frame for a first link;
the step of scheduling a flow including scheduling at least one flow for the first link; and
the step of adjusting the link speed including adjusting the link speed of the first link if the at least one flow utilizes less than the period of time allocated to for the first link.

11. The method as claimed in claim 1, further comprising the steps of:
the step of scheduling the plurality of links including scheduling at least one of the plurality of links for each of at least a series of frames; and
providing a variable length control region and a variable length data region for each frame of the series of frames.

12. The method as claimed in claim 1, further comprising the step of:
operating the link scheduler from an access point; and
operating the flow scheduler from a terminal.

13. The method as claimed in claim 12, further comprising the step of:
operating a plurality of flow schedulers from a plurality of terminals; and
positioning at least one of the plurality of terminals distant from the link scheduler.

14. The method as claimed in claim 1, further comprising the steps of:
allocating a period of time of a frame for a first link;
the step of scheduling the flow including scheduling at least one flow for the first link;
determining if the at least one flow scheduled for the first link requests bandwidth greater than the period of time allocated for the first link; and
scheduling a portion of the at least one flow such that the portion of the at least one flow is less than or equal to the allocated period of time.

15. A method for use in scheduling communications over a plurality of links, comprising the steps of:
receiving a plurality of requests for communication over one or more of the plurality of links;
prioritizing each of the plurality of links;
determining if there is sufficient available time in a frame to satisfy all the requests for communication; and
scheduling communication of all the requests if there is sufficient time in the frame.

16. The method as claimed in claim 15, further comprising the steps of:
scheduling less than all of the requests if there is insufficient time in the frame to satisfy all the requests based on the priority of each request, including scheduling the links having requests with reserved bandwidths before scheduling links without request having reserved bandwidths.

17. The method as claimed in claim 15, further comprising the steps of:
determining if there is sufficient available time to satisfy all links with reserved bandwidth;
scheduling all the links with reserved bandwidth if there is sufficient time to satisfy all the links with reserved bandwidth; and
scheduling less than all of the links with reserved bandwidth if there is insufficient time to satisfy all the links with reserved bandwidth.

18. The method as claimed in claim 17, wherein:
the step of scheduling less than all of the links with reserved bandwidth including:
identifying a link with the highest priority of the links having reserved bandwidth;
determining if there is sufficient available time to satisfy the highest priority link of the links with reserved bandwidth;
scheduling all requests for the highest priority link of the links with reserved bandwidth if there is sufficient time to satisfy the highest priority link of the links with reserved bandwidth; and
scheduling less than all of the requests for the highest priority link of the links with reserved bandwidth if there is insufficient time to satisfy the highest priority link of the links with reserved bandwidth.

19. The method as claimed in claim 18, wherein:
the step of identifying the highest priority link including:
determining if there is more than one link with the highest priority;
determining which of the more than one links with the highest priority is to be scheduled next according to a round-robin schedule; and
designating the link next on the round-robin schedule as the highest priority link of the links with reserved bandwidth.

20. The method as claimed in claim 18, further comprising the steps of:
the step of scheduling less than all of the requests for the highest priority link of the links with reserved bandwidth including:
prioritizing the plurality of requests attempting to be communicated across the highest priority link of the links with reserved bandwidth; and
scheduling as many of the requests attempting to be communicated as able to fit into an allocated time for the highest priority link.

21. The method as claimed in claim 15, further comprising the steps of:
identifying links without reserved bandwidth;
determining if there is sufficient available time to satisfy all links without reserved bandwidth;
scheduling all the links without reserved bandwidth if there is sufficient time in the frame to satisfy all the links without reserved bandwidth; and
scheduling less than all of the links without reserved bandwidth if there is insufficient time in the frame to satisfy all the links without reserved bandwidth.

22. The method as claimed in claim 21, further comprising the steps of:
the step of scheduling less than all of the links without reserved bandwidth including:
identifying a link with the highest priority of the links without reserved bandwidth;
determining if there is sufficient available time in the frame to satisfy the highest priority link of the links without reserved bandwidth;
scheduling all requests for the highest priority link of the links without reserved bandwidth if there is sufficient time to satisfy the highest priority link of the links without reserved bandwidth; and
scheduling less than all of the requests for the highest priority link of the links without reserved bandwidth if there is insufficient time to satisfy the highest priority link of the links without reserved bandwidth.

23. A method for scheduling flows to be communicated across a link, comprising the steps of:
receiving an allocated period of time in which to schedule flows;
determining if there is sufficient time in the allocated period of time to schedule all of the flows to be communicated;
scheduling all of the flows if there is sufficient time; and
scheduling as many of the flows that can be communicated within the allocated period of time if there is not sufficient time in the allocated period of time to schedule all of the flows.

24. The method as claimed in claim 23, further comprising the steps of:
determining a priority for each of the flows; and
the step of scheduling as many of the flows including scheduling the flows based on the priority of each flow.

25. The method as claimed in claim 24, further comprising the steps of:
identifying a highest priority of the flows;
determining if there is more than one flow having the highest priority; and
if there is more than one flow having the highest priority, scheduling the plurality of flows having the highest priority according to a round-robin schedule.

26. The method as claimed in claim 25, further comprising the step of:
scheduling the plurality of flows having the highest priority according to a round-robin schedule including:
determining if there is sufficient time to schedule the entire highest priority flow scheduled in the round-robin schedule; and
scheduling a first portion of the highest priority flow if there is insufficient time to schedule the entire highest priority flow.

27. The method as claimed in claim 24, further comprising the steps of:
determining a bandwidth needed for a second portion of the highest priority flow;
updating a bandwidth request of the highest priority flow based on a second portion not scheduled; and
maintaining a request for the highest priority flow requesting the needed bandwidth of the second portion.

28. A method for scheduling communication, comprising the steps of:
receiving a plurality of requests for communicating over a plurality of links;
determining a priority of each link; and
providing one of a plurality of degrees of qualities of service to each of the plurality of links.

29. The method as claimed in claim 28, wherein:
the step of providing one of a plurality of degrees of qualities of service including providing links having the same priority a same degree of quality of service.

30. The method as claimed in claim 29, wherein:
the step of determining a priority including:
determining if the plurality of links have reserved bandwidth; and
assigning each link of the plurality of links having reserved bandwidth a higher priority than links without reserved bandwidth.

31. The method as claimed in claim 30, further comprising the steps of:
receiving a new request;
determining a priority of the new request, wherein the priority is a first priority; and
the step of scheduling including scheduling the new request after all other previously received requests having the first priority.

32. A method of use in providing communication of data, comprising the steps of:
scheduling a plurality of links for communication during a plurality of frames; and
for each frame, allocating lengths of the frame for a control region and for one or more data regions, wherein the control region and the one or more data regions are of variable length.

33. The method as claimed in claim 32, further comprising the step of:
allocating a length of each of the plurality of frames for a control beacon, wherein the length is a variable length.

34. The method as claimed in claim 32, further comprising the step of:
allocating a first length of a first frame for a first control beacon; and
allocating a second length of a second frame for a second control beacon, wherein the first length and second length are of different lengths.

35. The method as claimed in claim 34, further comprising the step of:
allocating a third length for a first data region in the first frame; and
allocating a fourth length for the first data region in the second frame where the third length and the fourth length are of different lengths.

36. The method as claimed in claim 34, further comprising the step of:
for each frame of the plurality of frames, allocating a length of the frame to each link scheduled for communication in that frame;
allocating a third length for a first link in a first frame; and
allocating a fourth length for the first link in a second frame where the third length and the fourth length are of different lengths.

37. The method as claimed in claim 32, further comprising the steps of:
determining if a time to communicate data over a first link is less than the period of time allocated to the first link; and
reducing a link speed of the first link if the time to communicate the data is less than the period of time allocated to the first link.

38. An apparatus providing communication, comprising:
a link scheduler configured to schedule communication over a plurality of links, wherein the plurality of links are configured to provide communication paths for communicating data; and
a flow scheduler associated with at least one link of the plurality of links, wherein the flow scheduler is configured to schedule a data flow to be communicated across the at least one link.

39. The apparatus as claimed in claim 38, wherein:
the link scheduler being positioned geographically distant from the flow scheduler.

40. The apparatus as claimed in claim 38, wherein:
each of the plurality of links being associated with at least one of a plurality of flow schedulers configured to schedule flows.

41. The apparatus as claimed in claim 40, further comprising:
a first link being coupled at a first end with a first terminal having a first flow scheduler;
the first link being coupled at a second end with a second terminal having a second flow scheduler wherein information is communicated between the first and second terminals over the first link.

42. The apparatus as claimed in claim 40, further comprising:
a link-schedule list (LSL) generated by the link scheduler, and configured to define link scheduling.

43. The apparatus as claimed in claim 40, further comprising:
a scheduled flow transmission list (SFTL) generated by the flow scheduler, and configured to define flow scheduling.

44. The apparatus as claimed in claim 40, further comprising:
a reserved bandwidth table designating links with reserved bandwidth, wherein the link scheduler utilizes the reserved bandwidth table in scheduling links.

45. The apparatus as claimed in claim 40, further comprising:
a best-effort table designating links without reserved bandwidth, wherein the link scheduler utilizes the best-effort table in scheduling links.

46. The apparatus as claimed in claim 38, wherein:
the link scheduler being coupled with at least a subset of the plurality of links configured to provide communication paths for communicating data;
each link of the subset of the plurality of links being further coupled with one of a plurality of flow schedulers configured to schedule flows.

47. A method for use in providing communication scheduling, comprising:
scheduling at least one link communication within a time frame;
determining if less than the entire time frame is scheduled;
determining if a link speed associated with the at least one link communication can be reduced; and
reducing the link speed associated with the at least one link communication.

48. The method as claimed in claim 45, wherein scheduling includes scheduling a plurality of link communications within the time frame;
the determining if the link speed can be reduced includes determining if a plurality of link speeds associated with the plurality of link communications can be reduced; and
the reducing includes reducing the plurality of link speeds.
